(19) United States
(12) Patent Application Publication
(10) Pub. No.: US 2014/0122161 A1
(43) Pub. Date: May 1, 2014

(54) WORKFLOW-BASED PROJECT MANAGEMENT

(71) Applicant: Realization Technologies, Inc., San Jose, CA (US)

(72) Inventors: Sanjeev Gupta, San Jose, CA (US); Corvin Bazgan, San Carlos, CA (US); Ravi Shankar, San Jose, CA (US); Sridharan Chandrasekaran, Cupertino, CA (US)

(73) Assignee: Realization Technologies, Inc., San Jose, CA (US)

(21) Appl. No.: 14/066,348

(22) Filed: Oct. 29, 2013

Related U.S. Application Data
(60) Provisional application No. 61/719,872, filed on Oct. 29, 2012.

(51) Int. Cl. G06Q 10/06

(52) U.S. Cl. CPC G06Q 10/06316
USPC 705/7.26

(57) ABSTRACT

Systems and techniques are described for performing workflow-based project management. An embodiment can receive a scope tree and a sequence of steps, stages, and/or phases that one or more items in the scope tree go through. The embodiment can then generate a set of subprojects, streams, and/or tasks based on the received scope tree and the sequence of steps, stages, and/or phases. Note that each subproject, stream, or task is associated with an item in the scope tree and an item in the sequence of steps, stages, and/or phases. Next, the embodiment can generate a set of interdependencies between the set of subprojects, streams, and/or tasks based on the scope tree and the sequence of steps, stages, and/or phases. The embodiment can then create the project plan that includes the set of subprojects, streams, and/or tasks and the set of interdependencies between the set of subprojects, streams, and/or tasks.

### RELATED APPLICATION

This application claims priority to U.S. Provisional Patent Application No. 61/719,872, entitled “Stream-based project management,” by the same inventors, which has Attorney Docket No. REAL12-0004P, and was filed on 29 Oct. 2012, the contents of which are herein incorporated by reference in their entirety for all purposes.

### BACKGROUND

1. Technical Field

This disclosure relates to project management. More specifically, this disclosure relates to workflow-based project management.

2. Related Art

The term “project” generally refers to a temporally bounded endeavor which is designed to achieve specific goals and objectives. A project can be part of a larger project, and/or a project can have subprojects. A project is usually associated with a due date, i.e., a date by which a project needs to be completed. In conventional project management, a project is typically represented using a set of interdependent tasks. A task can be defined as a unit of work which needs to be performed within a specific time period. An organization may need to schedule multiple projects that may share personnel, resources, etc., among themselves.

Conventional task-based project management approaches have many limitations and drawbacks. The reasons for the limitations and drawbacks include: (1) not all the scope of work or not all the tasks associated with a scope of work may be known upfront, (2) it is difficult to capture all of the dependencies (e.g., an engineering work flow may have many unknown dependencies that are discovered only during project execution), (3) it is difficult to capture feedback loops in the workflow, (4) it is difficult to estimate task duration and effort, (5) skill levels used on tasks can vary and it is difficult to capture this fact, and (6) it is difficult to account for non-project work (i.e., non-project work includes emergent work that is not known or that cannot be planned for when the project is scheduled).

Another serious drawback of conventional task-based project management approaches is the inability to prevent runaway multitasking. Specifically, a given resource (e.g., one or more engineers) may have to work on multiple tasks at the same time because task schedules could not be followed as planned or additional tasks were added to the original plan. Then the overall efficiency of the resource decreases (e.g., due to switching costs). This decrease in efficiency can cause the current work to be delayed, which, in turn, can increase the degree of multitasking, thereby creating a runaway feedback loop that can cause very large delays. Additionally, project planning is extremely difficult, time consuming, and error prone because all of the data (e.g., the tasks and their interdependencies) has to be manually entered and project plans cannot be easily visualized. The result is poor and inconsistent planning, which sub-optimizes projects even before execution has begun.

### SUMMARY

Some embodiments described in this disclosure present a new project management approach that does not suffer from the above-described limitations and drawbacks that are present in almost all conventional task-based project management approaches. Unlike classic project management software that is built on unwieldy Gantt charts, embodiments described herein use workflow-based project management techniques and systems that significantly streamline planning and execution of projects.

Specifically, in some embodiments a scope tree can be received. Next, the embodiments can receive a sequence of steps, stages, and/or phases that one or more items in the scope tree go through. The embodiments can then automatically generate a set of subprojects, streams, and/or tasks based on the scope tree and the sequence of steps, stages, and/or phases. Note that each subproject, stream, or task is associated with an item in the scope tree and an item in the sequence of steps, stages, and/or phases. Next, the embodiments can automatically generate a set of interdependencies between the set of subprojects, streams, and/or tasks based on the scope tree and the sequence of steps, stages, and/or phases. The embodiments can create a project plan that includes the set of subprojects, streams, and/or tasks and the set of interdependencies. The embodiments can also present the set of subprojects, streams, and/or tasks and the set of interdependencies in a graphical user interface (GUI).

Note that the user is not required to manually create the set of subprojects, streams, and/or tasks, and is also not required to create the set of interdependencies. Once the initial set of subprojects, streams, and/or tasks has been automatically generated, the GUI can enable the user to add, delete, and/or modify one or more subprojects, streams, and/or tasks in the project plan. Likewise, once the initial set of interdependencies has been automatically generated, the GUI can enable the user to add, delete, and/or modify one or more interdependencies in the set of interdependencies.

The GUI can present the automatically generated set of subprojects, streams, and/or tasks in a tabular format. In some embodiments, each item in the scope tree corresponds to a row and each item in the sequence of steps, stages, and/or phases corresponds to a column. In other embodiments, each item in the scope tree corresponds to a column and each item in the sequence of steps, stages, and/or phases corresponds to a row.

In some embodiments, the system can receive resource constraints, and release dates and due dates for one or more subprojects, streams, and/or tasks in the project plan. Next, the system can schedule the subprojects, streams, and/or tasks in the project plan based on the set of interdependencies, the release dates, the due dates, and the resource constraints. Additionally, some embodiments can determine a critical path component and a resource constraint component in the total duration of the scheduled project plan, and report the critical path contribution and the resource constraint contribution to the user.

### BRIEF DESCRIPTION OF THE FIGURES

FIG. 1A illustrates a graphical user interface (GUI) that a system can use to enable a user to create a project plan in accordance with some embodiments described herein.

FIG. 1B illustrates GUI 100 after the user has selected the subprojects, streams, and/or tasks in the project in accordance with some embodiments described herein.

FIG. 1C illustrates how a single stream shown in FIG. 1B may include multiple circuit design steps in accordance with some embodiments described herein.

FIG. 1D shows how the computer system can infer dependencies and present the inferred dependencies to the user in accordance with some embodiments described herein.

FIG. 1E illustrates how a user can select a project scope and assign a milestone deadline to the selected project scope in accordance with some embodiments described herein.

FIG. 1F illustrates how multiple workflow-based GUIs can be used for creating a project plan in accordance with some embodiments described herein.

FIG. 2 presents a flowchart that illustrates a process for providing a GUI to a user to create a project plan in accordance with some embodiments described herein.

FIG. 3A illustrates an example of how streams from multiple projects can be scheduled in accordance with some embodiments described herein.

FIG. 3B illustrates a process for reporting the critical path component and the resource constraint component in the total duration of a project schedule in accordance with some embodiments described herein.

FIG. 4 presents a flowchart that illustrates a process for prioritizing subprojects, streams, and/or tasks in accordance with some embodiments described herein.

FIG. 5 illustrates a process for updating a project schedule (in real time or near real time) in accordance with some embodiments described herein.

FIG. 6 illustrates a computer system in accordance with some embodiments described in this disclosure.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein. In this disclosure, when the term “and/or” is used with a list of entities, it refers to all possible combinations of the list of entities. For example, the phrase “X, Y, and/or Z” covers the following cases: (1) only X; (2) only Y; (3) only Z; (4) X and Y; (5) X and Z; (6) Y and Z; and (7) X, Y, and Z.

### Workflow-Based Project Management

The smallest unit of work that is managed in the project can be a subproject, a stream, or a task. A subproject can be a project that is part of a larger project. All systems and techniques disclosed herein that can be used for managing a project can also be used for managing a subproject. A task is typically a relatively small unit of work that is usually performed by a single person (e.g., an employee operating a particular machine) and lasts for a duration that is relatively shorter than the typical duration for which a stream lasts. However, in some situations the terms “task” and “stream” can correspond to the same amount of work.

Workflow-based project management systems described in this disclosure are fundamentally different from conventional project management systems. The differences between a conventional project management system and workflow-based project management will become apparent in the following discussion.

A project typically has one or more deliverables. For example, the project deliverable for a chip design project is the chip that is created at the end of the project. Similarly, the project deliverable for a software design project is the software that is created at the end of the project. As yet another example, the project deliverable of a residential construction project is the house that is built.

The team that is working on the project (e.g., an engineering team) typically breaks down (often in a hierarchical fashion) the project deliverable into smaller pieces, which can be referred to as “components of the project deliverable” (or “components” for short). Each component of a project deliverable corresponds to a portion of the project deliverable, and the components may be organized in a hierarchical fashion. For example, if the project deliverable is a circuit design, then each functional block (e.g., the graphics engine, the memory, the CPU, etc.) in a circuit design can correspond to a component of the project deliverable, and then each functional block may be broken down into smaller components (e.g., the CPU may be broken down into a floating point unit component, an arithmetic unit component, etc.). As another example, if the project deliverable is a multi-storied building, then each floor in the multi-storied building can correspond to a component of the project deliverable at the highest level in the hierarchy, and each floor may be further broken down into different rooms or structures within the floor.

In this disclosure the hierarchical breakdown of a project deliverable into individual components is referred to as the “scope tree” and each component is referred to as an “item in the scope tree.” A scope tree can have one or more hierarchical levels. When the scope tree has a single level, the scope tree can be represented by a list of items. Note that an item of the scope tree (i.e., a component of a project deliverable) is fundamentally different from a task. Specifically, a task usually corresponds to an activity that is performed by a person. However, an item of a scope tree (i.e., a component of a project deliverable) corresponds to a portion of the scope tree (i.e., a portion of the deliverable) that is produced or outputted during or at the end of the project. Hereinafter the terms “project deliverable,” and “scope tree” will be used interchangeably, and the terms “a component of a project deliverable” and “an item of a scope tree” will also be used interchangeably.

In a typical engineering workflow, each component of a project deliverable goes through one or more steps, stages, or phases. For example, a graphics engine of a chip may go through a requirements definition phase, a system specifications phase, an implementation phase, a physical placement phase, and a test phase. Each of these phases is performed on the graphics engine in a given order. For example, the requirements definition phase is performed first, and then the system specifications phase is performed, and so forth. A subproject, stream, or task can be used to represent a phase that is performed on the graphics engine. According to one definition, a phase or a stage includes multiple steps. In this disclosure the term “phase” has been used to describe some of the embodiments. However, the term “phase” has been used for illustration purposes only and is not intended to limit the scope of the disclosed embodiments. The systems and techniques disclosed herein can also be applied to steps and/or stages.

Note that a project can be thought of as having (1) a scope tree (also known as a hierarchy of components of the project deliverable or a work breakdown structure), and (2) a sequence of phases (or stages or steps) that one or more portions of the scope tree (i.e., components of the project deliverable) go through. According to one definition, a task (or a subproject or a stream) represents a step (or a stage or a phase) in a project that is performed on a given item of the scope tree (i.e., a component of the project deliverable).

Creating a Project Plan

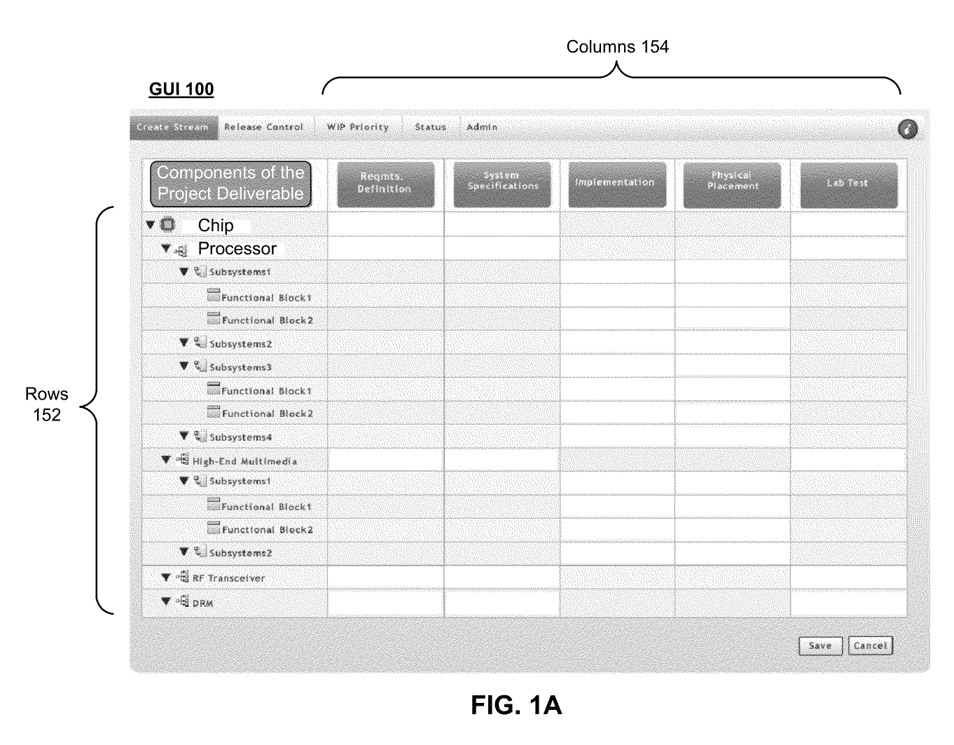

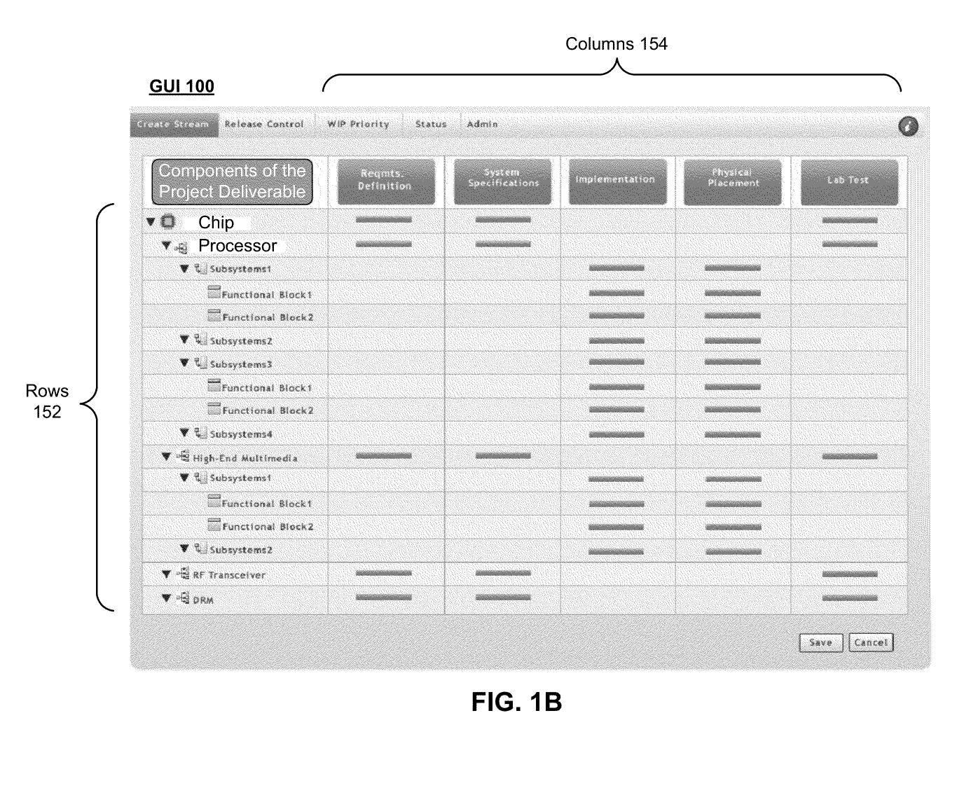

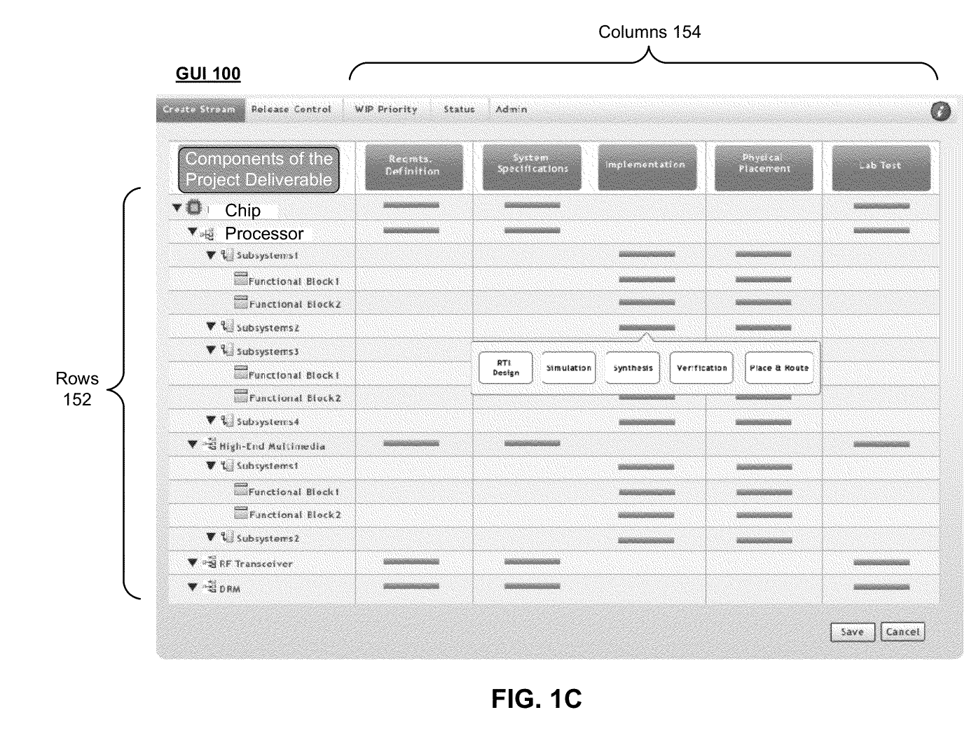

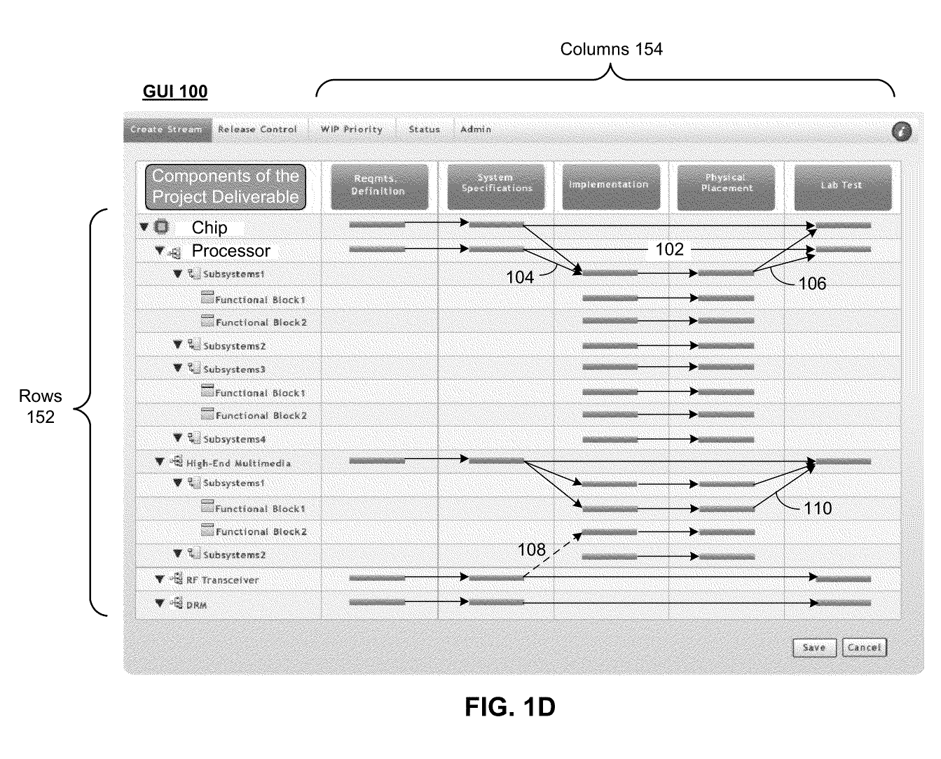

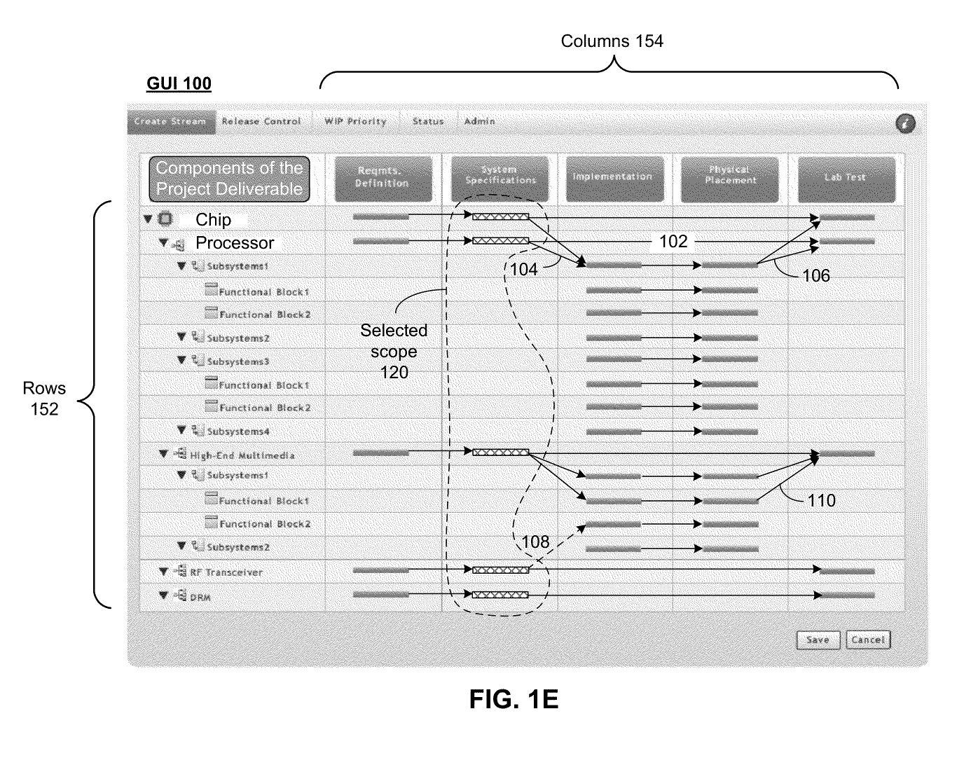

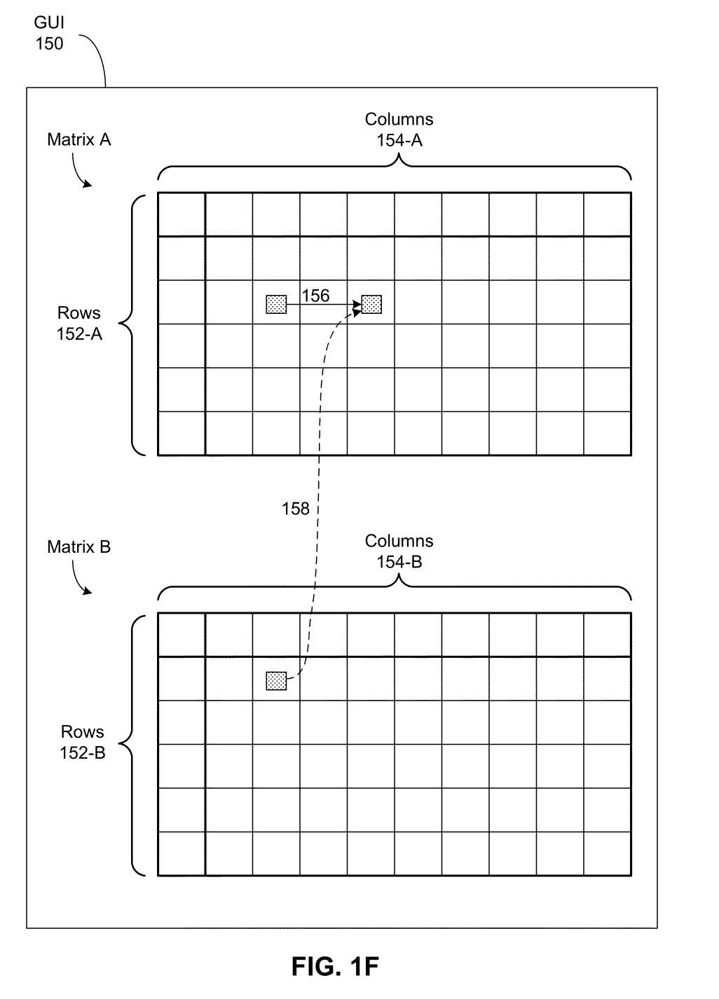

In some embodiments, a workflow-based project management system (e.g., a computer system that is executing a workflow-based project management software application) enables the user to create a project plan. FIG. 1A illustrates a GUI that a system can use to enable a user to create a project plan in accordance with some embodiments described herein. The GUI illustrated in FIG. 1A can be referred to as the planning matrix. The term “matrix” is used in this disclosure to generally refer to the layout of information in the project management GUI. The GUI itself may be implemented using any software application that is capable of presenting information in a matrix layout. For example, a workflow-based project management GUI can be implemented as a web application, as an executable that is installed on a personal computer, as a document for an application (e.g., as a spreadsheet document which, when opened by a spreadsheet application, implements the workflow-based project management GUI), etc.

Each row in GUI 100 corresponds to a component of the project deliverable. Note that rows 152 are indented to show a hierarchy of components in the project deliverable. For example, the first row is labeled “Chip” and it identifies the project deliverable, and it corresponds to the highest level in the hierarchy. The second row is entitled “Processor” and it represents a component of the project deliverable. The component “Processor” has multiple subcomponents which are labeled “Subsystems1,” “Subsystems2,” etc. and are indented within the component “Processor.” In other words, the set of rows represents the scope tree.

Columns 154 in GUI 100 correspond to steps or phases and are labeled as such. For example, as shown in FIG. 1A, the different steps or phases that any component of the project deliverable may go through include requirements definition, system specifications, implementation, physical placement, and lab test. (In another embodiment, the rows and columns can be switched, i.e., each row can correspond to a step, and each column can correspond to an item in the scope tree.)

The combination of a row and a column can correspond to a subproject, stream, or task. Note that not all row/column intersections correspond to a subproject, stream, or task. The set of all row/column intersections represents the total universe of subprojects, streams, and/or tasks that are presented to the user through the GUI. The user can then select the subprojects, streams, and/or tasks that actually exist in the project.

In some embodiments, the computer system requests the user to provide the scope tree (i.e., the hierarchy of components of the project deliverable), and the sequence of steps or phases. For example, the user may input the scope tree as a first hierarchical list and the sequence of steps or phases as a second hierarchical list.

Specifically, some embodiments enable a user to specify and store components of a project deliverable in the form of a scope tree. For example, an embodiment (e.g., a project management software application) can provide a GUI that enables a user to input the components of a project deliverable in the form of a scope tree, and that displays the scope tree to the user. Once the user is satisfied with the hierarchical structure and the contents of the scope tree, the user can save the scope tree and/or instruct the embodiment to use the scope tree for creating a project plan. Some embodiments can store workflow templates. A workflow template can specify the sequence of steps of the workflow and a set of rules for automatically creating interdependencies between the steps of the workflow. Some embodiments can provide a GUI to the user to create a workflow based on a workflow template, and to view and edit the workflow. Once the user is satisfied with the structure and contents of the workflow, the GUI can enable the user to save the workflow and/or use the workflow to create a project and/or subproject plan.

Next, the computer system can create a GUI (e.g., GUI 100) that easily allows the user to input the subprojects, streams, and/or tasks in the project plan. For example, GUI 100 may enable a user to click on an element of the matrix (or cell of a table) to access the subproject, stream, or task that exists at the intersection of the corresponding component and step (or phase).

FIG. 1B illustrates GUI 100 after the user has selected the subprojects, streams, and/or tasks in the project in accordance with some embodiments described herein. If we look across the first row (i.e., the row labeled “Chip”), then we note that a chip goes through a requirements definition phase, a system specifications phase, and a lab test phase. Each of these phases in the first row represents a subproject, stream, or task, and is shown in GUI 100 by a bar. Likewise, the third row that corresponds to “Subsystems1” in the processor has two subprojects, streams, and/or tasks—one that corresponds to the implementation phase and another that corresponds to the physical placement phase. Note that each subproject, stream, or task corresponds to a component of the project deliverable (identified by the row heading) and a step or phase (identified by the column heading). For example, stream 170 corresponds to performing the “System Specifications” step/phase on component “High-End Multimedia.”

A task, subproject, or stream can exist at any intersection of a component of the product deliverable and a step or phase. Specifically, it is possible to have streams that correspond to the same step or phase but that correspond to different levels in the component hierarchy. For example, the “Implementation” phase in FIG. 1B includes a stream for “Subsystems1” (within the component “Processor”) and also streams for “Functional Block” and “Functional Block2.” In this case, the stream that exists at the intersection of phase “Implementation” and component “Functional Block1” is self-explanatory, namely, this stream represents the “Implementation” phase for “Functional Block1.” Similarly, the stream that exists at the intersection of phase “Implementation” and component “Functional Block2” is also self-explanatory. Note that “Subsystems1” includes two functional blocks, namely “Functional Block1” and “Functional Block2.” However, “Subsystems1” may also include additional circuitry that is not part of “Functional Block1” or “Functional Block2.” The stream that exists at the intersection of the phase called “Implementation” and the component called “Subsystems1” covers the implementation of this additional circuitry.

Each subproject, stream, or task (i.e., each bar shown in FIG. 1B) can include a complex and time-consuming work flow within it. FIG. 1C illustrates how a single stream shown in FIG. 1B may include multiple circuit design steps in accordance with some embodiments described herein. For example, as shown in FIG. 1C, a single subproject, stream, or task may include the following circuit design steps: RTL (register transfer logic) design, simulation, synthesis, verification, and place & route. Each of these circuit design steps can be complex and can require multiple engineers to work for multiple weeks to achieve the desired goals and/or objectives.

Note that each subproject, stream, or task in the matrix (or table) is inherently associated with an item of the scope tree (i.e., the row) and a step or phase or stage (i.e., the column). Therefore, the underlying data structure that stores the project plan must be capable of associating the subproject, task, and/or stream with an item in the scope tree and also be capable of associating the subproject, task, and/or stream with a step, phase, or stage in the sequence of steps, phases, and/or stages that were specified for creating the project plan. When the project plan is stored in a non-transitory computer-readable storage medium, these associations (e.g., the association between a subproject, task, and/or stream and an item in the scope tree, and the association between the subproject, task, and/or stream and a step, phase, or stage in the sequence of steps, phases, and/or stages) are automatically stored in the non-transitory computer-readable storage medium.

Once the user specifies the subprojects, streams, and/or tasks, the computer system can automatically infer dependencies between the subprojects, streams, and/or tasks. Note that, in general, a dependency can be created by the user between any two subprojects, streams, and/or tasks. However, in workflow-based project management, many of the dependencies can be inferred. This is very beneficial because it saves the user from manually creating each and every dependency.

Inferring Dependencies

FIG. 1D shows how the computer system can infer dependencies and present the inferred dependencies to the user in accordance with some embodiments described herein. Note that only a few of the inferred dependencies are shown in FIG. 1D for the sake of clarity. After reading the description shown below, it will be apparent to a person having ordinary skill in the art that many more dependencies can be inferred in FIG. 1D.

Specifically, a dependency can be automatically inferred in at least the following situations. (The direction of the inferred dependency is from left to right, i.e., from an earlier phase to a later phase.)
1. A dependency can be inferred between two adjacent subprojects, streams, and/or tasks in the same row. Two subprojects, streams, and/or tasks in the same row are adjacent to one another if there are no subprojects, streams, and/or tasks between them. An example of this type of dependency is shown by dependency 102 in FIG. 1D (dependency 102 is from the stream “Processor/System Specifications” to the stream “Processor/Lab Test”).
2. A dependency can be inferred between two adjacent subprojects, streams, and/or tasks in two different rows, if one row is within the component hierarchy tree of another row. For example, the third row (labeled “Subsystems1”) is a subcomponent of the second row (labeled “Processor”). Therefore, dependencies 104 and 106 can be inferred as shown in FIG. 1D.
3. A dependency can also be inferred between two subprojects, streams, and/or tasks that are separated by multiple hierarchy levels. For example, dependency 110 crosses two levels of hierarchy because “Functional Block1” is a subcomponent of “Subsystems1,” which is a subcomponent of “High-End Multimedia.”

The inferred dependencies can be presented to the user. The user can then use GUI 100 to either remove one or more inferred dependencies or add dependencies that were not inferred automatically. For example, the user may add dependency 108 as shown by the dashed line in FIG. 1D by using GUI 100.

FIG. 1E illustrates how a user can select a project scope and assign a milestone deadline to the selected project scope in accordance with some embodiments described herein. The GUI can allow an arbitrary set of subprojects, streams, and/or tasks to be selected. For example, a user can select scope 120 as shown in FIG. 1E. Next, the selected scope can be assigned a new release date and/or due date. The release date is the date when the engineering group can start working on the subproject, stream, or task, and the due date is the date when the subproject, stream, or task is planned to be completed.

In some embodiments, the GUI enables a user to specify a milestone due date at an intersection between a column and a row in the tabular format, wherein the milestone due date is associated with an item that corresponds to the row and is also associated with all items in the scope tree hierarchy that are under the item. For example, if a due date is assigned to the subproject, stream, and/or task at the intersection of the column called “Implementation” and the row called “Subsystems3,” then this due date is automatically assigned to the subprojects, streams, and/or tasks that are in the scope tree hierarchy that are under the this intersection point. Specifically, in this example, the due date will also be assigned to the subprojects, streams, and/or tasks that are at the intersection points of the following rows and columns: (1) row called “Functional Block1” under “Subsystems3” in the scope hierarchy and column called “Implementation,” and (2) row called “Functional Block2” under “Subsystems3” in the scope hierarchy and column called “Implementation.”

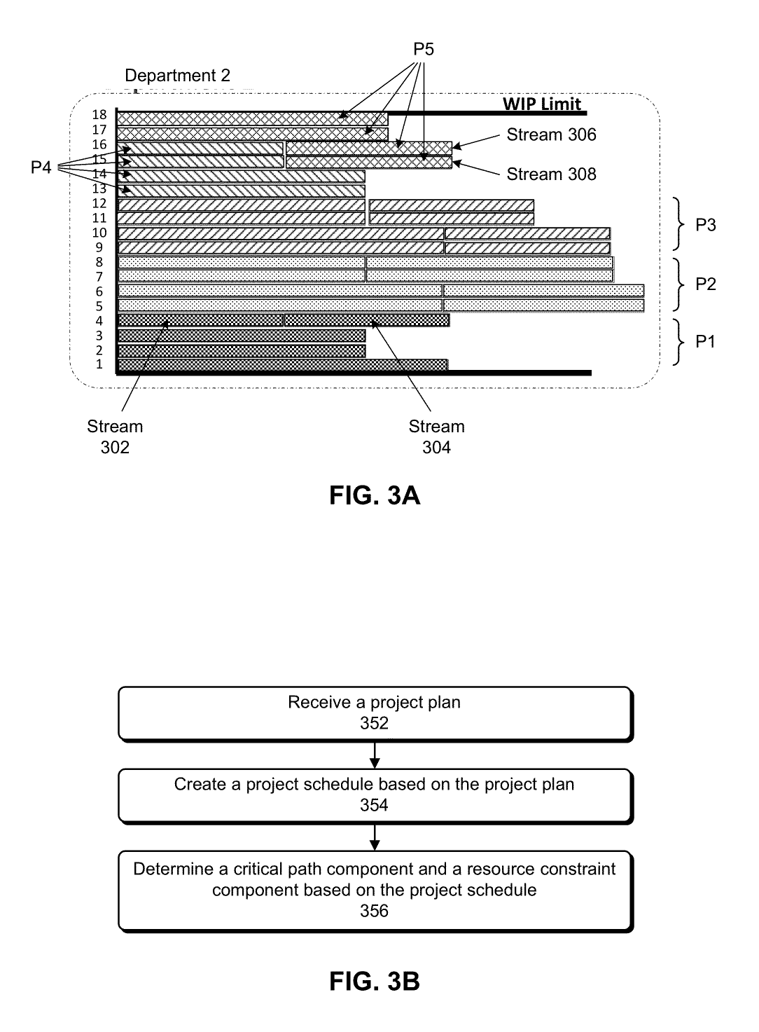

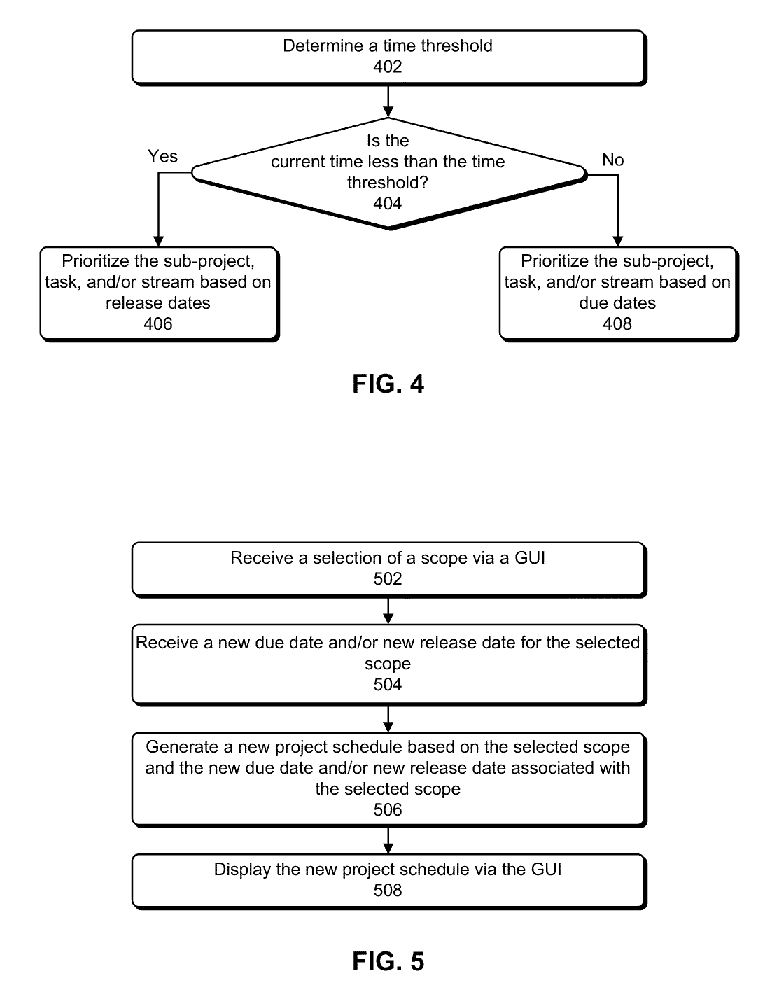

As explained below in reference to FIGS. 3A, 3B, and 4, the release dates and due dates can be used during project scheduling and/or during prioritization. Specifically, the project scheduling process will try to ensure that the subprojects, streams, and/or tasks in the selected scope are planned to be worked on beginning on the release date, and are planned to be completed on or before the due date.

FIG. 1F illustrates how multiple workflow-based GUIs can be used for creating a project plan in accordance with some embodiments described herein. In some cases the project may include two or more teams that work on different parts of the project in a mostly independent manner. In such situations, multiple matrices—each matrix corresponding to different teams—can be generated and presented. For example, a smartphone project may have a hardware subproject and a software subproject, and a project plan may need to be created for each subproject. In this case, a matrix may be generated for each of the subprojects, and the system can also allow the user to create dependencies between elements of one matrix and elements of the other matrix.

For example, GUI 150 includes two matrices—matrices A and B—which correspond to different subprojects within the project (e.g., a hardware subproject and a software subproject). The example shown in FIG. 1F is for illustration purposes only and is not intended to limit the scope of the disclosed embodiments. For example, instead of the two matrices shown in FIG. 1F, GUI 150 may include more than two matrices in some embodiments.

For each of the two matrices, the user can provide a scope tree and a sequence of steps, stages, and/or phases. For example, rows 152-A can correspond to items in the scope tree for the first subproject, and columns 154-A can correspond to the items in the sequence of steps, stages, and/or phases in the first subproject. Likewise rows 152-B can correspond to the scope tree for the second subproject and columns 154-B can correspond to the sequence of steps, stages, and/or phases in the second subproject. Dependencies within a given subproject can be inferred as explained above in reference to FIG. 1D. For example, dependency 156 can be inferred automatically. Dependencies between entities in two different matrices, such as dependency 158, can be manually added by the user (also as explained in reference to FIG. 1D) or can be automatically inferred or created by the system by executing a set of user-defined rules.

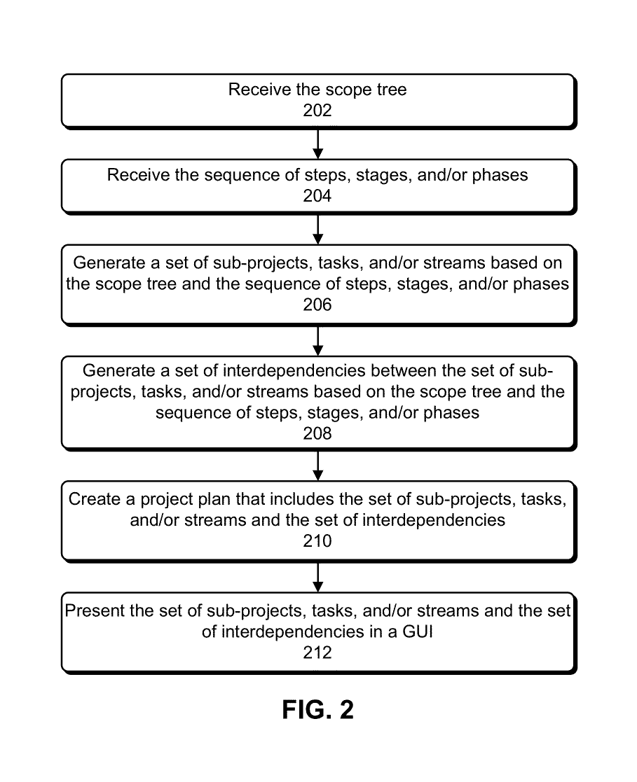

FIG. 2 presents a flowchart that illustrates a process for providing a GUI to a user to create a project plan in accordance with some embodiments described herein. The system can first request the user to provide the scope tree, e.g., the hierarchy of components of the project deliverable. The system can then receive the scope tree (operation 202), e.g., the hierarchy of components that is shown in the first column of FIG. 1A. Next, the system can request the user to provide the sequence of steps, stages, and/or phases that one or more components may go through. The system can then receive the sequence of steps, stages, and/or phases (operation 204) (e.g., the stages called “requirements definition,” “system specifications,” “implementation,” etc. as shown in FIGS. 1A-1E). Next, the system can generate a set of subprojects, streams, and/or tasks based on the scope tree and the sequence of steps, stages, and/or phases (operation 206). The system can then generate a set of interdependencies between the set of subprojects, streams, and/or tasks based on the scope tree and the sequence of steps, stages, and/or phases (operation 208). Next, the system can create the project plan that includes the set of subprojects, streams, and/or tasks and the set of interdependencies (operation 210). The system can then present the set of subprojects, streams, and/or tasks and the set of interdependencies in a GUI (operation 212).

For example, the system can present a matrix (e.g., GUI 100 in FIGS. 1A-1E) to the user in which the rows correspond to the scope tree and the columns correspond to the sequence of steps, stages, and/or phases. The user can use the GUI to add, delete, and/or modify the subprojects, streams, and/or tasks in the project. The user can also use the GUI to add, delete, and/or modify an interdependency between two or more subprojects, streams, and/or tasks.

In some embodiments, the user can use the GUI to provide the following information for an element in the matrix: (1) a resource or engineering group that will work on the subproject, stream, or task that corresponds to the element, and (2) the approximate amount of time that will be required by the resource or engineering group to complete the subproject, stream, or task that corresponds to the element. Additionally, for each resource or engineering group that is specified by the user, the system may also ask the user to enter a work-in-process limit for the resource or engineering group (the meaning of the term “work-in-process limit” and how this limit is used during scheduling the different streams is explained below).

GUI 100 was presented for illustration purposes only and is not intended to limit the embodiments disclosed herein. It will be apparent to one having ordinary skill in the art that many modifications and variations of the GUI are possible that would convey similar information as GUI 100, and that would enable the user to add, delete, and/or modify the subprojects, streams, and/or tasks (which were automatically generated based on the scope tree and the sequence of steps, stages, and/or phases) in a manner similar to GUI 100. For example, in a variation, the rows and columns in GUI 100 may be swapped, i.e., the rows may correspond to the sequence of steps, stages, and/or phases, and the columns may correspond to the scope tree.

Scheduling a Workflow-Based Project

A project plan can be scheduled based on the set of interdependencies and the project due date while taking into account any WIP limits (if specified), any resources constraints (if specified), and any milestone due dates (if specified). As mentioned above, each subproject, stream, or task is worked on by a resource or an engineering group. In workflow-based project management, the user (e.g., a manager of an engineering team) provides the following high-level information for each resource or engineering group: the number of different subprojects, streams, and/or tasks that the resource or engineering group can work on at any given time (this limit is called the work-in-process limit). When the different subprojects, streams, and/or tasks are scheduled, the system ensures that the work-in-process limit is not violated.

FIG. 3A illustrates an example of how streams from multiple projects can be scheduled in accordance with some embodiments described herein. The X-axis in FIG. 3A represents time. “Department 2” is an engineering group whose work-in-process (WIP) limit is 18, i.e., the engineering group can concurrently work on 18 different subprojects, streams, and/or tasks.

The different projects may have different priorities, and the subprojects, streams, and/or tasks are allocated to an engineering group in order of decreasing priority. For example, five streams (such as streams 302 and 304) from project P1 (which has the highest priority) are first assigned to Department 2. Note that streams 302 and 304 were not performed concurrently. This is because stream 304 can only be performed after stream 302 is performed (e.g., because a dependency exists between stream 302 and stream 304—note that the dependency may have been automatically generated based on the scope tree and the sequence of steps, stages, and/or phases or the dependency may have been added or modified by a user via a GUI).

Next, the streams from projects P2, P3, and P4 are scheduled in that order. When the streams from project P5 (these streams are shown with a cross-hatch pattern) are scheduled, streams 306 and 308 from project P5 have to be scheduled after the streams from project P4 are completed to ensure that the WIP limit is not violated.

The system can also report how much of the project schedule duration is because of the critical path and because of resource bottlenecks. According to one definition, a critical path is the longest necessary path or chain of subprojects, streams, and/or tasks in the project plan. Stated differently, a critical path is a sequence of subprojects, streams, and/or tasks which add up to the longest overall duration. The critical path in a project corresponds to the minimum amount of time (based on the planned durations) required to complete the project. Any delay in a subproject, stream, or task in the critical path consumes the project buffer or impacts the planned project completion date (if the project does not have a project buffer at the end or if the project buffer has been completely consumed). Further details on how a critical path can be determined can be found in U.S. application Ser. No. 12/610,264, entitled “Post facto identification and prioritization of causes of buffer consumption,” having attorney docket no. REAL09-0004, which was filed on 30 Oct. 2009, the contents of which are herein incorporated by reference in their entirety for all purposes. As explained above, a WIP limit can be specified for a given resource. In some embodiments, a resource constraint (i.e., a constraint that specifies the number of subprojects, streams, and/or tasks that can simultaneously use a given resource) can be imposed on the project schedule.

To separate the impact of the critical path and resource bottlenecks, the system can create two schedules—one without considering resource constraints and one that does consider resource constraints. Then, the system can determine a difference in the completion dates of these two schedules to determine the impact that resource constraints are having on the schedule. The remaining portion of the project schedule duration is due to the critical path. This information can help the user to identify whether or not adding more resources will improve the project schedule. For example, suppose the total project is expected to take 40 weeks, and the duration attributable to the critical path is 39 weeks and to resource constraints is one week. Based on this information, the project manager may focus his/her efforts on reducing the critical path duration (e.g., by increasing the amount of parallelism in the underlying workflow) instead of trying to allocate more resources to the project.

FIG. 3B illustrates a process for reporting the critical path component and the resource constraint component in the total duration of a project schedule in accordance with some embodiments described herein.

The process can begin with receiving a project plan (operation 352). Next, the process can create a project schedule based on the project plan (operation 354). The process can then determine a critical path component and a resource constraint component based on the project schedule (operation 356). For example, in one embodiment, the process can create a first project schedule that satisfies a set of resource constraints, and create a second project schedule that ignores the set of resource constraints. Next, the process can determine a critical path component and a resource constraint component based on the first and second project schedules. In another embodiment, the process can determine a critical path in the project schedule. Next, the process can sum the durations of subprojects, streams, and/or tasks in the critical path. The sum corresponds to the critical path component, and the difference between the sum and the total project duration can correspond to the resource constraint component. Once the critical path component and the resource constraint component have been determined, the process can then report these components to a user. For example, this information can be presented visually in the form of a bar graph, a pie chart, etc.

Conventional project management tools schedule and track tasks at the same level of granularity. In contrast, some embodiments described herein can create a representation of the project plan at multiple levels of granularity, and each level of granularity can be used for a different project management function. In some embodiments, scheduling can be performed at a coarser level of granularity and tracking (i.e., processing status updates) can be performed at a finer level of granularity. For example, scheduling is typically performed by a project manager who may not need or want to know the low-level details of the project plan, and hence the scheduling tool may present the project plan to the project manager at a coarser level of granularity (e.g., the project may be represented as a network of phases at the coarser level of granularity, wherein each phase may include tens or hundreds of interdependent tasks). However, tracking is typically performed by task managers who may need to provide detailed task status updates, and so the tool may present the project plan to the task manager at a finer level of granularity (e.g., the project may be shown in terms of the individual tasks).

Prioritizing Subprojects, Streams, and/or Tasks

Some embodiments can prioritize subprojects, streams, and/or tasks so that resources or engineering groups know which subprojects, streams, and/or tasks to work on. FIG. 4 presents a flowchart that illustrates a process for prioritizing subprojects, streams, and/or tasks in accordance with some embodiments described herein. The process shown in FIG. 4 is for illustration purposes only and is not intended to limit the embodiments disclosed herein. The process begins with determining a time threshold (operation 402). For example, the time threshold could be a percentage (e.g., 50%) of the nominal amount of time required to complete a subproject, stream, or task.

Next, the system determines if the current time is less than the time threshold (operation 404). For example, suppose the time threshold is 2 weeks from a start time T0 (the time threshold can be dependent on the expected duration of the subproject, stream, or task, e.g., as explained above the time threshold can be a percentage of the expected duration of the subproject, stream, or task). Then during the first two weeks (i.e., from time T0 to time T0+2 weeks), the system will determine that the current time is less than the time threshold. After time T0+2 weeks, the system will determine that the current time is greater than the time threshold.

If the current time is less than the time threshold, then the system prioritizes the subproject, stream, or task based on the release dates (operation 406). The release date is the date when the engineering group can start working on the subproject, stream, or task. On the other hand, if the current time is greater than the time threshold, then the system prioritizes the subproject, stream, or task based on the due dates (operation 408). The due date is the date when the subproject, stream, or task is planned to be completed.

In general, some embodiments use a prioritization process that becomes increasingly sensitive to the due date (and less sensitive to the release date) as time progresses. The process illustrated in FIG. 4 represents one embodiment of such a prioritization process. Many variations and modifications of the disclosed embodiment are possible.

Note that the prioritization process described herein is fundamentally different from conventional project management systems where a task manager has to periodically (e.g., on a daily basis) update statuses of subprojects, streams, and/or tasks so that the project management system can compute the priorities of the different subprojects, streams, and/or tasks. In contrast to conventional project management systems, the workflow-based project management system described in this disclosure prioritizes work based on the release date (i.e., the date when the subproject, stream, or task was ready to be worked on) and the due date (i.e., the date when the subproject, stream, or task was scheduled to be completed). The release and due dates are typically known when the subproject, stream, or task are specified (e.g., by using the process shown in FIG. 2 and GUI 100) by the user and do not change during project execution. Therefore, in workflow-based project management, a user (e.g., a project manager) may not be required to periodically update the status of the subproject, stream, or task in order for the system to prioritize work.

What-If Functionality

If we change the due date and/or the release date of one or more subprojects, streams, and/or tasks, then that can cause the project schedule to change. Some embodiments described herein can enable the user to interactively observe the impact on the project schedule by adding, deleting, and/or modifying release dates and/or due dates of one or more subprojects, streams, and/or tasks. Specifically, in some embodiments, the system can provide a GUI to the user (e.g., GUI 100 shown in FIG. 1E) that can be used to select a scope and assign a new due date and/or new release date to the selected scope. Based on the inputted information, the system can schedule subprojects, streams, and/or tasks (e.g., by using the process shown in FIG. 4), and display the new schedule to the user and optionally highlight the changes with respect to the old schedule.

FIG. 5 illustrates a process for updating a project schedule (in real time or near real time) in accordance with some embodiments described herein. The process can begin by receiving a selection of a scope via a GUI (operation 502). For example, the user can select a scope via a workflow-based project planning GUI as shown in FIG. 1E. Next, a new due date and/or new release date can be received for the selected scope (operation 504). The process can then generate a new project schedule based on the selected scope and the new due date and/or new release date associated with the selected scope (operation 506). For example, the new project schedule can be generated using the process shown in FIG. 4. Next, the process can display the new project schedule via the GUI (operation 508). Operations 506 and 508 can be performed in real time or near real time to enable a user to interactively explore different “what-if” scenarios by using the GUI. Specifically, the tool can enable the user to add, delete, and/or modify release and/or due dates to see how the changes impact the project schedule. Some embodiments allow the user to select a scope (e.g., from a drop-down menu, or by clicking on a GUI element that corresponds to a particular scope, etc.), and then the embodiments highlight all subprojects, streams, and/or tasks that are associated with the selected scope.

Specifically, in some embodiments, the tool can receive a deselection of an item in the scope tree (e.g., the user can use the GUI to deselect an item in the scope tree). For example, the user can click on click on an item of the scope tree and instruct the tool to remove, ignore, and/or deselect the item for scheduling purposes. Next, the tool can remove subprojects, streams, and/or tasks from the project plan that are associated with the item in the scope tree. This operation also involves removing any interdependencies corresponding to the subprojects, streams, and/or tasks that were removed due to the deselection. The tool can then reschedule the project plan based on the updated set of subprojects, streams, and/or tasks, and the updated set of interdependencies. For example, suppose the user specifies a milestone due date for “Subsystems3” as explained in reference to FIG. 1E. The tool can then schedule the project plan that takes this new milestone due date information into account. Let us assume that the user then deselects “Functional Block2” under “Subsystems3.” Then, the tool can remove all subprojects, streams, and/or tasks (and any related interdependencies) that correspond to item “Functional Block2” that is under “Subsystems3.” The tool can then reschedule the project plan based on the updated information.

Note that, in conventional approaches, the user would have to individually remove each subproject, stream, and/or task, and also individually handle the interdependencies corresponding to the subprojects, streams, and/or tasks that were removed. In contrast to such conventional approaches, some embodiments described herein enable the user to easily ignore or remove (e.g., for scheduling purposes only) all subprojects, streams, and/or tasks that are associated with one or more items in the scope tree, thereby enabling the user to quickly check different “what-if” scenarios.

### Computer System

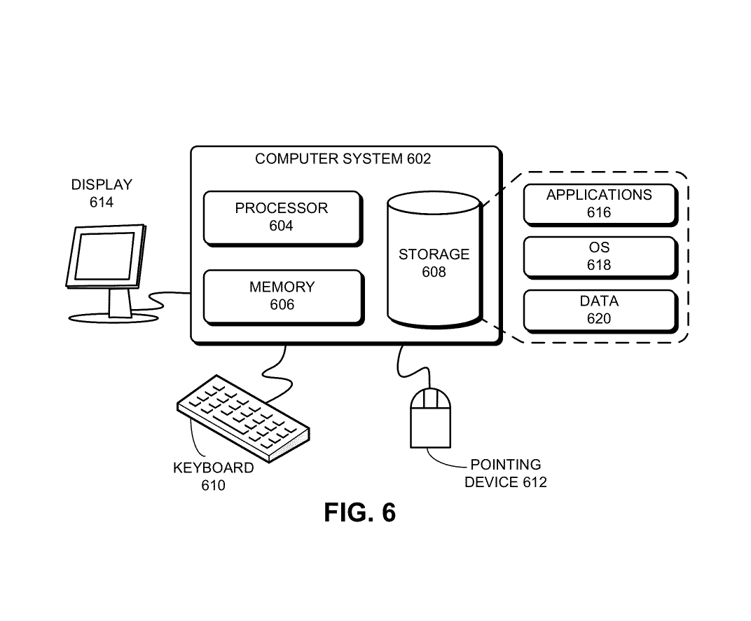

FIG. 6 illustrates a computer system in accordance with some embodiments described in this disclosure.

A computer system can generally be any system that can perform computations. Specifically, a computer system can be a microprocessor, a network processor, a portable computing device, a personal organizer, a device controller, a distributed computer, a cloud computing system, a computational engine within an appliance, or any other computing system now known or later developed. Computer system 602 comprises processor 604, memory 606, and storage 608. Computer system 602 can be coupled with display 614, keyboard 610, and pointing device 612. Storage 608 can generally be any device that can store data. Specifically, a storage device can be a magnetic, an optical, or a magneto-optical storage device, or it can be based on flash memory and/or battery-backed up memory. In some embodiments, storage 608 can be a non-transitory computer-readable storage medium. The term “non-transitory computer-readable storage medium” includes all storage mediums (e.g., volatile and non-volatile memories) with the sole exception of a propagating electromagnetic signal or wave. Storage 608 can store applications 616, operating system 618, and data 620.

Applications 616 can include instructions that when executed by computer system 602 cause computer system 602 to perform one or more processes that are described explicitly or implicitly in this disclosure. Data 620 can generally include any information that is inputted into, and/or that is outputted from the one or more processes that are described implicitly or explicitly in this disclosure. Computer system 602 can generate signals that can be provided to display 614 to present information to a user. For example, computer system 602 can generate signals that can be provided to display 614 to present a GUI to a user.

The foregoing description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

What is claimed is:

1. A method for creating a project plan, the method comprising:
a computer receiving a scope tree and a sequence of steps, stages, and/or phases that one or more items in the scope tree go through;
the computer generating a set of subprojects, streams, and/or tasks based on the scope tree and the sequence of steps, stages, and/or phases;
the computer generating a set of interdependencies between the set of subprojects, streams, and/or tasks based on the scope tree and the sequence of steps, stages, and/or phases; and
the computer creating the project plan that includes the generated set of subprojects, streams, and/or tasks and the generated set of interdependencies between the generated set of subprojects, streams, and/or tasks.

2. The method of claim 1, wherein each subproject, stream, or task is associated with an item in the scope tree and an item in the sequence of steps, stages, and/or phases.

3. The method of claim 1, further comprising presenting the created project plan in a graphical user interface (GUI).

4. The method of claim 3, wherein the GUI enables a user to add, delete, and/or modify one or more subprojects, streams, and/or tasks in the project plan.

5. The method of claim 3, wherein the GUI enables a user to add, delete, and/or modify one or more interdependencies in the project plan.

6. The method of claim 3, wherein the GUI presents the generated set of subprojects, streams, and/or tasks in a tabular format, wherein each item in the scope tree corresponds to a row and each item in the sequence of steps, stages, and/or phases corresponds to a column.

7. The method of claim 3, wherein the GUI presents the generated set of subprojects, streams, and/or tasks in a tabular format, wherein each item in the scope tree corresponds to a column and each item in the sequence of steps, stages, and/or phases corresponds to a row.

8. The method of claim 7, wherein the GUI enables a user to specify a milestone due date at an intersection between a column and a row in the tabular format, wherein the milestone due date is associated with an item that corresponds to the row and is also associated with all items in the scope tree hierarchy that are under the item.

9. The method of claim 1, further comprising:
scheduling the project plan based on the set of interdependencies, a project due date, resource constraints, and optionally one or more milestone due dates;
receiving a deselection of an item in the scope tree;
removing subprojects, streams, and/or tasks from the project plan that are associated with the deselected item in the scope tree; and
rescheduling the project plan.

10. The method of claim 1, further comprising:
scheduling the project plan based on the set of interdependencies, one or more milestone due dates, a project due date, and one or more resource constraints;
determining a critical path component and a resource constraint component in the total duration of the scheduled project plan; and
reporting the critical path contribution and the resource constraint contribution.

11. A non-transitory computer-readable storage medium storing instructions that, when executed by a computer, cause the computer to perform a method for creating a project plan, the method comprising:
receiving a scope tree and a sequence of steps, stages, and/or phases that one or more items in the scope tree go through;
generating a set of subprojects, streams, and/or tasks based on the scope tree and the sequence of steps, stages, and/or phases;
generating a set of interdependencies between the set of subprojects, streams, and/or tasks based on the scope tree and the sequence of steps, stages, and/or phases; and
creating a project plan that includes the generated set of subprojects, streams, and/or tasks and the generated set of interdependencies between the generated set of subprojects, streams, and/or tasks.

12. A computer system, comprising:
a processor; and
a non-transitory computer-readable storage medium storing instructions that, when executed by a computer, cause the computer to perform a method for creating a project plan, the method comprising:
receiving a scope tree and a sequence of steps, stages, and/or phases that one or more items in the scope tree go through;
generating a set of subprojects, streams, and/or tasks based on the scope tree and the sequence of steps, stages, and/or phases;
generating a set of interdependencies between the set of subprojects, streams, and/or tasks based on the scope tree and the sequence of steps, stages, and/or phases; and
creating the project plan that includes the generated set of subprojects, streams, and/or tasks and the generated set of interdependencies between the generated set of subprojects, streams, and/or tasks.
